(19) United States
(12) Patent Application Publication
(10) Pub. No.: US 2022/0250327 A1
(43) Pub. Date: Aug. 11, 2022

(54) AGENT FORMULATION DETERMINATION BASED ON SURFACE ORIENTATIONS OF 3D MODELS

(71) Applicant: Hewlett-Packard Development Company, L.P., Spring, TX (US)

(72) Inventors: Matthew A. SHEPHERD, Vancouver, WA (US); Jacob WRIGHT, San Diego, CA (US); Dennis J. SCHISSLER, San Diego, CA (US); Vanessa VERZWYVELT, Vancouver, WA (US); Xin CHENG, Vancouver, WA (US); Morgan T. SCHRAMM, Vancouver, WA (US)

(73) Assignee: Hewlett-Packard Development Company, L.P., Spring, TX (US)

(21) Appl. No.: 17/312,841

(22) PCT Filed: Apr. 29, 2019
(86) PCT No.: PCT/US2019/029712

§ 371 Date: Jun. 10, 2021

(51) Int. Cl. B29C 64/393; B33Y 10/00; B33Y 50/02; H04N 1/409; B33Y 30/00

(52) U.S. Cl. CPC B29C 64/393; B33Y 10/00; B29C 64/165; H04N 1/409; B33Y 30/00; B33Y 50/02

(57) ABSTRACT

According to examples, an apparatus may include a processor and a memory on which are stored machine-readable instructions that when executed by the processor, may cause the processor to identify an orientation of a surface of a three-dimensional (3D) model. The instructions may also cause the processor to, based on the identified orientation of the surface, determine an agent formulation to be employed in fabricating a section of a 3D printed part corresponding to the surface, in which each of a plurality of different orientations of surfaces of the 3D model corresponds to a respective different agent formulation.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may determine an agent formulation to be employed in fabricating a section of a 3D printed part based on an orientation of a 3D model;

FIG. 2 shows a diagram of an example 3D fabrication system in which the apparatus depicted in FIG. 1 may be implemented;

FIG. 3 depicts a block diagram of an example apparatus that may determine an agent formulation to be employed in fabricating a section of a 3D printed part based on an orientation of a 3D model;

FIGS. 4A and 4B, respectively, show a diagram of a surface and a normal angle to the surface and a diagram for use in selecting a formulation map or a combination of formulation maps for use in generating an agent formulation for a surface;

FIG. 5 shows an example method for generating an agent formulation to be employed in fabricating a section of a 3D printed part corresponding to a face of a 3D model based on an orientation of the face; and

FIG. 6 shows a block diagram of an example computer readable medium that may have stored thereon machine readable instructions that when executed by a processor, may cause the processor to generate agent formulations to be used to fabricate a section of a 3D printed part that corresponds to a surface of a 3D model.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

3D printed parts may exhibit anisotropies in optical color and/or mechanical properties depending upon the directions that surfaces of the 3D printed parts face. For instance, some 3D printers may produce different colors on the top surface of a 3D printed part compared to the bottom, or sides, even though the same amounts, e.g., volumes, of agents are used to print each of the bottom, side, and top surfaces.

Disclosed herein are apparatuses, methods, and computer readable media that may determine an agent formulation to be employed in fabricating a section of a 3D printed part corresponding to a surface of 3D model based on the orientation of the surface. That is, for instance, an orientation of the surface of the 3D model may be identified, and based on the identified orientation of the surface, an agent formulation to be employed in fabricating the section of the 3D printed part corresponding to the surface may be determined. In addition, each of a plurality of different orientations of surfaces of the 3D model may correspond to a respective different agent formulation.

The determined agent formulation for a surface may define the amounts, e.g., volumes, drop numbers, locations of drops, etc., at which an agent is or multiple agents are to be applied onto respective layers of build material particles to fabricate the section of the 3D printed part corresponding to the surface. The agent or agents may include an agent that may modify the build material particles on which the agent is deposited and/or absorbed. The modification may be a mechanical, chemical, physical, or the like, modification to the build material particles. For instance, the agent may cause the build material particles to melt (after application of energy onto the build material particles), coalesce, bind, fuse, or the like. In addition, or alternatively, the agent may apply an optical property to the build material particles, such as, color, transparency, opacity, or the like. Thus, for instance the determined agent formulation may include a formulation of multiple agents that may modify a color and physical property of the build material particles.

According to examples, each of a plurality of different orientations of surfaces of the 3D model may correspond to a respective different agent formulation, e.g., for a given color. Thus, for instance, multiple agent formulations may correspond to the same particular color of a surface. As discussed herein, the agent formulation for a surface may be determined from agent information contained in a formulation map or contained in multiple formulation maps. In instances in which the agent formulation for the surface is determined from multiple formulation maps, an interpolation operation may be performed using the agent information.

As discussed herein, the use of the same agent formulation for all of the surfaces of a 3D printed part may result in anisotropies in color and/or mechanical properties on the surfaces depending on the direction in which the surface faces. Through implementation of the features of the present disclosure, multiple agent formulations may be determined for the surfaces of the 3D printed part and the agent formulations may be interpolated for surfaces that do not face one of a specified number of directions. The multiple agent formulations and the interpolations may be developed such that there is greater accuracy and/or uniformity in optical properties and/or strength properties among the surfaces of the 3D printed part regardless of the directions in which surfaces face.

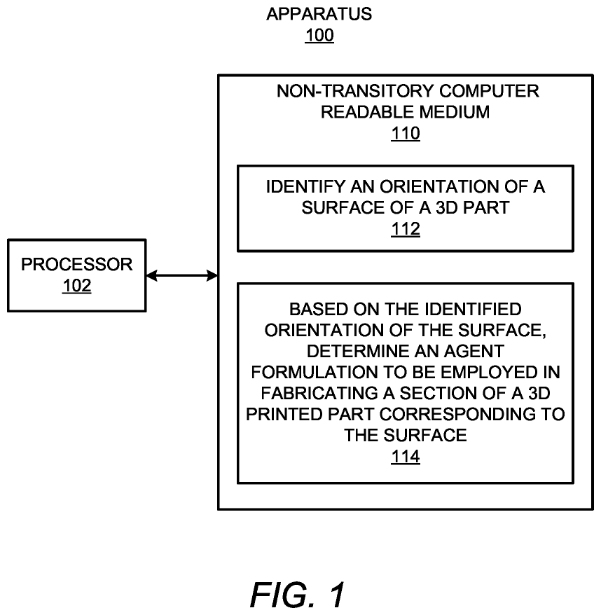

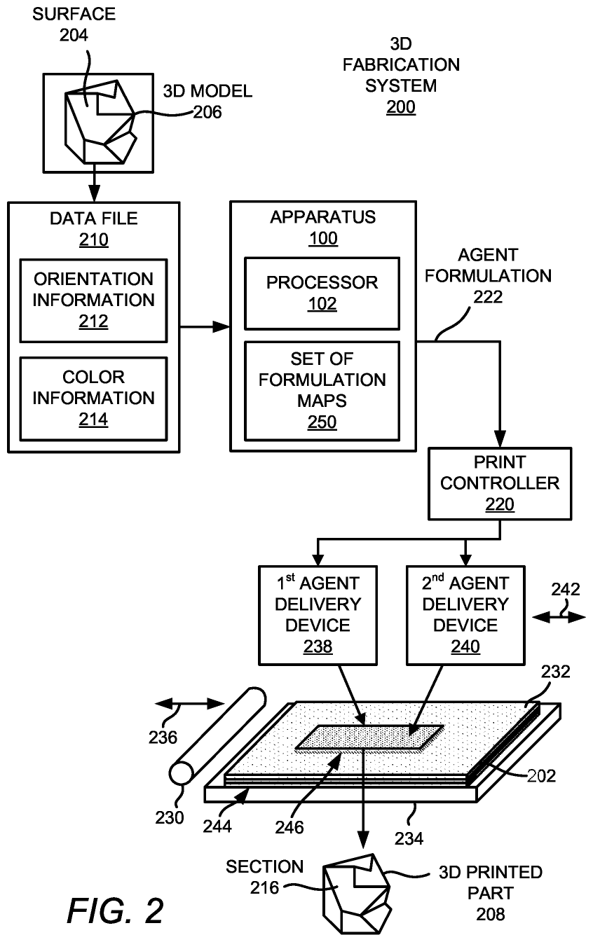

Reference is made first to FIGS. 1 and 2. FIG. 1 shows a block diagram of an example apparatus 100 that may determine an agent formulation to be employed in fabricating a section of a 3D printed part based on an orientation of a surface of a 3D model. The apparatus 100 may determine the agent formulation for the section, for instance, to mitigate anisotropy in sections of the 3D printed part with respect to each other. FIG. 2 shows a diagram of an example 3D fabrication system 200 in which the apparatus 100 depicted in FIG. 1 may be implemented. It should be understood that the example apparatus 100 depicted in FIG. 1 and the example 3D fabrication system 200 depicted in FIG. 2 may include additional features and that some of the features described herein may be removed and/or modified without departing from the scopes of the apparatus 100 or the 3D fabrication system 200.

The apparatus 100 may be a computing device, a tablet computer, a server computer, a smartphone, or the like. The apparatus 100 may alternatively be part of the 3D fabrication system 200, e.g., a CPU of the 3D fabrication system 200. Although the apparatus 100 is depicted as including a single processor 102, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate or equivalently, print, 3D parts through selectively solidifying build material particles 202, which may also be termed particles 202 of build material. In some examples, the 3D fabrication system 200 may use agents to selectively bind and/or solidify the particles 202. In particular examples, the 3D fabrication system 200 may use agents that increase the absorption of fusing energy to selectively fuse the particles 202 on which the agents are deposited. In addition, the 3D fabrication system 200 may use colorant agents to apply color to sections of 3D printed parts. The colorants, or colorant agents, may be differently colored inks, such as inks having one of cyan, magenta, yellow, or black colors, although the 3D fabrication system 200 may use additional or other colored inks.

According to one example, a suitable agent may be an ink-type formulation including carbon black, such as, for example, the agent formulation commercially known as V1Q60AQ “HP fusing agent” available from HP Inc. In one example, such an agent may additionally include an infra-red light absorber. In one example such agent may additionally include a near infra-red light absorber. In one example, such an agent may additionally include a visible light absorber. In one example, such an agent may additionally include a UV light absorber. Examples of agents including visible light enhancers are dye based colored ink and pigment based colored ink, such as inks commercially known as CE039A and CE042A available from HP Inc. According to one example, the 3D fabrication system 200 may additionally use an agent that may reduce or impede coalescence, e.g., fusing, of build material particles 202 onto which the agent has been deposited and/or absorbed. According to one example, a suitable type of such an agent may be a formulation commercially known as V1Q61A “HP detailing agent” available from HP Inc.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a non-transitory computer readable medium 110 that may have stored thereon machine readable instructions 112-114 (which may also be termed computer readable instructions) that the processor 102 may execute. The non-transitory computer readable medium 110 may be an electronic, magnetic, optical, or other physical storage device that contains or stores executable instructions, where the term “non-transitory” does not encompass transitory propagating signals. The non-transitory computer readable medium 110 may be, for example, Random Access memory (RAM), an Electrically Erasable Programmable Read-Only Memory (EEPROM), a storage device, an optical disc, and the like. The non-transitory computer readable medium 110 may also be referred to as a memory.

The processor 102 may fetch, decode, and execute the instructions 112 to identify an orientation of a surface 204 of a three-dimensional (3D) model 206. The 3D model 306 may be a data representation of a part to be fabricated. Particularly, for instance, a data file 210 may contain information about the 3D model 206 that the processor 102 may access to determine printing parameters, e.g., agent formulations, to be used in fabricating a 3D printed part 208. For instance, the data file 210 may contain information pertaining to features of the 3D model 206, such as physical dimensions, orientation information 212 of surfaces, color information 214, etc. The orientation information 212 may include, for instance, the angles at which surfaces of the 3D model 206 extend. Thus, for instance, the processor 102 may determine the orientation of the surface 204 from the orientation information 212. In some examples, the processor 102 may determine the orientation of the surface 204 as a normal angle to a plane of the surface 204. It should be understood that the 3D model 206 depicted in FIG. 2 is merely an example and should thus not be construed as limiting the present disclosure in any respect.

Although particular reference is made to the processor 102 identifying the orientation of the surface 204, the processor 102 may identify the orientations of each of the surfaces forming the 3D model 206. In this regard, the description of processes implemented with regard to the surface 204 may be applicable to the other surfaces of the 3D model 206.

The processor 102 may fetch, decode, and execute the instructions 114 to, based on the identified orientation of the surface 204, determine an agent formulation to be employed in fabricating a section 216 of a 3D printed part 208 corresponding to the surface 204. The agent formulation may define the amounts, e.g., volumes, drop numbers, locations of drops, etc., at which an agent is or multiple agents are to be applied onto respective layers of build material particles 202 to fabricate the section 216 of the 3D printed part 208. For instance, the agent formulation may define the amounts that a modifying agent (e.g., a fusing agent), a colorant agent, and a coalescence modification agent (e.g., a detailing agent) are to be applied to fabricate the section 216 of the 3D printed part 208. The agent formulation may also or alternatively define the amounts that an agent including both a fusing agent and a colorant agent are to be applied to fabricate the section 216 of the 3D printed part 208. According to examples, each of a plurality of different orientations of surfaces of the 3D model 206 may correspond to a respective different agent formulation. Thus, for instance, multiple agent formulations may correspond to the same particular color of a surface.

As discussed herein, the processor 102 may determine the agent formulation such that the section 216 of the 3D printed part 208 may be fabricated to have a color that accurately matches the color of the surface 204 of the 3D model 206. This may include determining an agent formulation that includes the deposition of multiple colorant agents having respective different colors. In addition, or alternatively, the processor 102 may determine the agent formulation such that the section 216 may be fabricated to have a property that is consistent with a property of other sections of the 3D printed part 208. In other words, the processor 102 may determine the agent formulation for the section 216 and the other sections of the 3D printed part 208 to mitigate anisotropy among the sections of the 3D printed part 208. For instance, the processor 102 may determine the agent formulation such that the section 216 may have a consistent optical characteristic, a consistent mechanical property, or both a consistent optical characteristic and a consistent mechanical property with respect to other sections of the 3D printed part 208.

For instance, the section 216 may have the same or similar color as sections having orientations that differ from the orientation of the section 216. Likewise, the section 216 may have the same or similar glossiness, translucency, surface finish, or the like, as the other sections. In addition, or alternatively, the section 216 may have the same or similar strength, rigidity, elasticity, or the like, as sections having orientations that differ from the orientation of the section 216.

As shown in FIG. 2, the 3D fabrication system 200 may include a print controller 220 that may control operations of components of the 3D fabrication system 200 to fabricate the 3D printed part 208. That is, the processor 102 may communicate the determined agent formulation 222 to the print controller 220 and the print controller 220 may control operations of the components based on the received agent formulation 222 to fabricate the section 216. The processor 102 may also communicate agent formulations for the other sections of the 3D printed part 208 to the print controller 220.

The 3D fabrication system 200 may include a spreader 230 that the print controller 220 may control to spread the build material particles 202 into a layer 232, e.g., through movement across a platform 234 as indicated by the arrow 236. As also shown in FIG. 2, the 3D fabrication system 200 may include a first agent delivery device 238 and a second agent delivery device 240, although additional agent delivery devices may also be included. The first agent delivery device 238 and the second agent delivery device 240 may be scanned in the direction denoted by the arrow 242, in a direction perpendicular to the arrow 242, and/or in other directions. In addition, or alternatively, the platform 234 on which the layers 232 are deposited may be scanned in directions with respect to the first agent delivery device 238 and the second agent delivery device 240. Although not shown, the 3D fabrication system 200 may include an energy source that may output energy onto the layer 232 as the energy source is scanned across the layer 232 as denoted by the arrow 242. The energy source may be a laser beam source, a heating lamp, or the like, that may apply energy onto the layer 232 and/or that may apply energy onto the selected area 244.

The 3D fabrication system 200 may include a build zone 244 within which the components of the 3D fabrication system 200 may solidify the build material particles 202 in a selected area 246 of the layer 232. The selected area 246 of a layer 232 may correspond to a section of the 3D printed part 208 being fabricated in multiple layers 232 of the build material particles 202. The 3D fabrication system 200 may fabricate the 3D printed part 208 through selective deposition of a first agent and a second agent on respective layers 232 of the build material particles 202. The first agent may be an agent that is to modify a mechanical property of the build material particles 202 and the second agent may be an agent that is to modify an optical property of the build material particles 202. Although not shown, the 3D fabrication system 200 may include an additional agent delivery device that may deliver a similar type of agent, another type of agent, or the combinations thereof. Thus, for instance, the print controller 220 may control the agent delivery devices 238, 240 to selectively deposit the first agent, multiple second agents, and in some instances, a third agent (e.g., a detailing agent), onto respective layers 232 according to the determined agent formulations to fabricate the 3D printed part 208.

A first type of agent, such as a fusing agent, may enhance absorption of energy to cause the build material particles 202 upon which the agent has been deposited to melt. The first type agent may be applied to the build material particles 202 prior to application of energy onto the build material particles 202. In other examples, the first agent delivery device 238 may deliver a binding agent, such as an adhesive that may bind build material particles 202 upon which the binding agent is deposited.

In some examples, instead of the non-transitory computer readable medium 110, the apparatus 100 may include hardware logic blocks that may perform functions similar to the instructions 112-114. In yet other examples, the apparatus 100 may include a combination of instructions and hardware logic blocks to implement or execute functions corresponding to the instructions 112-114. In any of these examples, the processor 102 may implement the hardware logic blocks and/or execute the instructions 112-114. As discussed herein, the apparatus 100 may also include additional instructions and/or hardware logic blocks such that the processor 102 may execute operations in addition to or in place of those discussed above with respect to FIG. 1.

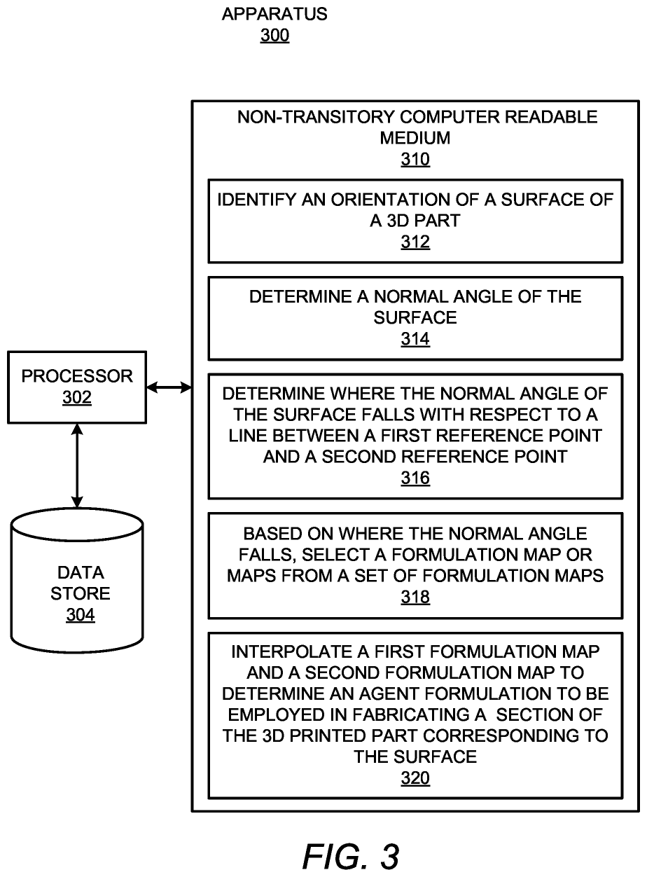

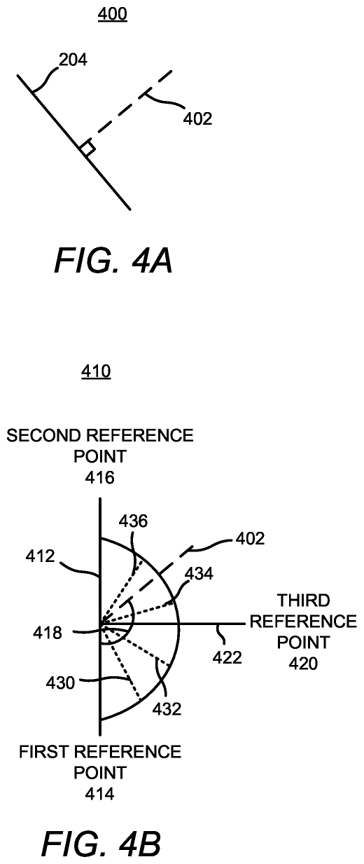

Turning now to FIG. 3, there is shown a block diagram of an example apparatus 300 that may determine an agent formulation to be employed in fabricating a section 216 of a 3D printed part 208. The apparatus 300 may determine the agent formulation for the section, for instance, to mitigate anisotropy in sections of the 3D printed part 208. It should be understood that the example apparatus 300 depicted in FIG. 3 may include additional features and that some of the features described herein may be removed and/or modified without departing from the scope of the apparatus 300. The description of the apparatus 300 is made with respect to the 3D fabrication system 200 shown in FIG. 2 as well as the diagrams 400 and 410 respectively depicted in FIGS. 4A and 4B.

The apparatus 300 may be equivalent to the apparatus 100 depicted in FIG. 1. As shown in FIG. 3, the apparatus 300 may include a processor 302 that may control operations of the apparatus 300 and a non-transitory computer readable medium 310 that may have stored thereon machine readable instructions 312-316 (which may also be termed computer readable instructions) that the processor 302 may execute. The processor 302 and the non-transitory computer readable medium 310 may be similar to the processor 102 and the non-transitory computer readable medium depicted in FIG. 1.

The processor 302 may fetch, decode, and execute the instructions 312 to identify an orientation of a surface 204 of a three-dimensional (3D) model 206. The processor 302 may identify the orientation of the surface 204 as discussed above with respect to the apparatus 100. For instance, the processor 302 may identify the orientation of the surface 204 from the orientation information 212 contained in the data file 210.

The processor 302 may fetch, decode, and execute the instructions 314 to determine a normal angle 402 of the surface 204. An example of the surface 204 and an angle 402 that is normal to the angle at which the surface 204 extends is depicted in the diagram 400 of FIG. 4A.

The processor 302 may fetch, decode, and execute the instructions 316 to determine where the normal angle 402 falls with respect to a line 412 between a first reference point 414 and a second reference point 416, for instance, as shown in the diagram 410 of FIG. 4B. The processor 302 may also fetch, decode, and execute the instructions 318 to, based on where the normal angle 402 falls with respect to the line 412, select a formulation map or multiple formulation maps to be used in determining the agent formulation to be employed in fabricating the section 216 of the 3D printed part 208 corresponding to the surface 204. The processor 302 may select the formulation map or the multiple formulation maps from a set of formulation maps 250, which may, for instance, be stored in a data store 304. Each of the formulation maps in the set 250 may identify, for a particular color and/or surface orientation, the agent formulation to be used to fabricate the section 216 corresponding to the surface.

According to examples, the set of formulation maps 250 may have been generated to cause sections of a 3D printed part 208 that are formed using the formulation maps 250 to have a consistent optical characteristic, a consistent mechanical property, or both a consistent optical characteristic and a consistent mechanical property with respect to each other regardless of the orientations of the sections. The agent information identified in the formulation maps 250 to result in the consistent characteristics, e.g., mitigation of anisotropies among the sections, may be determined through empirical testing, modeling, and/or the like. In addition, the agent information identified in the formulation maps 250 may vary for different types of 3D fabrication systems, different types of build materials, different types of fusing agents, different types of colorant agents, etc.

According to examples, the set of formulation maps 250 may include formulation maps that are mapped to various input colors and/or various orientations. Thus, for instance, the set of formulation maps 250 may include a first formulation map that maps to a first input color and a first surface orientation, a second formulation map that maps to the first input color and a second surface orientation, and a third formulation map that maps to the first input color and a third surface orientation. The set of formulation maps 250 may additionally include a number of formulation maps that map to a second input color and multiple orientations. The multiple orientations may include, for instance, a first orientation that faces downward. e.g., a bottom surface, a second orientation that faces to upward, e.g., a top surface, and a third orientation that faces to a side, e.g., a side surface.

According to examples, the processor 302 may determine where the normal angle 402 falls with respect to the line 412 as shown in the diagram 410 of FIG. 4B and may select the formulation map or the multiple formulation maps based on wherein the normal angle 402 falls. That is, the diagram 410 may denote which formulation map or multiple formulation maps of the set of formulation maps 250 that the processor 302 may select for use in determining an agent formulation for the surface 204. For example, in an instance in which the normal angle 402 of a surface 204 extends vertically down with respect to the line 412, e.g., in the direction of the first reference point 414, the processor 302 may select a first formulation map for use in determining the agent formulation for the surface 204. As another example, in an instance in which the normal angle 402 of the surface 204 extends vertically up with respect to the line 412, e.g., in the direction of the second reference point 416, the processor 302 may select a second formulation map for use in determining the agent formulation for the surface 204. As a further example, in an instance in which the normal angle 402 of the surface 204 extends horizontally, e.g., perpendicularly, with respect to the line 412, e.g., along a second line 422 that is in the direction of a third reference point 420 or in an opposite direction of the third reference point 420, the processor 302 may select a third formulation map for use in determining the agent formulation for the surface 204.

In some instances, the normal angle 402 of the surface 204 may not be aligned with either the line 412 or the second line 422. That is, for instance, the normal angle 402 may fall between the line 412 and the second line 422 as represented in the diagram 410. In these instances, the processor 302 may fetch, decode, and execute the instructions 320 to interpolate a first formulation map and a second formulation map to determine the agent formulation to be used to fabricate the section 216 corresponding to the surface 204. That is, for instance, the processor 302 may interpolate the agent information in the first formulation map with the agent information in the second formulation map to determine the agent formulation to be used. The interpolation may include, for instance, averaging the agent information identified in the first formulation map with the agent information identified in the second formulation map. In addition or alternatively, the interpolation may include applying a weighting operation, for instance, a linearly changing weighting, an exponentially changing weighting, a weighting that may change according to another mathematical function, or the like, to either or both of the agent information identified in the first formulation map and the second formulation map. The weighting may pertain to the agent information in one of the formulation maps being weighted more than the agent information in the other one of the formulation maps.

By way of example, in an instance in which the normal angle 402 extends at an angle 418 that is closer to the first reference point 414, the agent information identified in the first formulation map may be weighted higher than the agent information identified in the second formulation map. In addition, the weighting may linearly or exponentially change as the angle of the normal angle 402 increases with respect to the first reference point 414. In the example shown in FIG. 4B, the first formulation map may correspond to a side surface formulation map and the second formulation map may correspond to a top surface formulation map.

In any regard, the interpolations that the processor 302 may apply to multiple formulation maps may be determined through empirical testing, modeling, and/or the like. In addition, the interpolations may have been generated to cause sections of a 3D printed part that are formed using the interpolated formulation maps 250 to have a consistent optical characteristic, a consistent mechanical property, or both a consistent optical characteristic and a consistent mechanical property with respect to each other regardless of the orientations of the sections. The interpolations of the formulation maps 250 may be determined to result in the consistent characteristics, e.g., mitigation of anisotropies among the sections.

According to examples, the processor 302 may interpolate, e.g., mix the agent information identified in multiple formulation maps when the normal angle 402 extends beyond a predefined angle with respect to the line 412 and/or the second line 422. That is, for instance, and as shown in FIG. 4B, in an instance in which the normal angle 402 falls between an acute angle formed between the line 412 and a first boundary line 430, the processor 302 may select a first formulation map to be used. In an instance in which the normal angle 402 falls between the first boundary line 430 and a second boundary line 432, the processor 302 may select a first formulation map and a second formulation map to be used, and may interpolate the agent information identified in both formulation maps. In an instance in which the normal angle 402 falls between the second boundary line 432 and a third boundary line 434, the processor 302 may select the second formulation map to be used. In an instance in which the normal angle 402 falls between the third boundary line 434 and a fourth boundary line 436, the processor 302 may select the second formulation map and a third formulation map to be used and may interpolate the agent information identified in both formulation maps. In an instance in which the normal angle 402 falls between an acute angle formed between the fourth boundary line 436 and the line 412, the processor 302 may select the third formulation map.

The angles of the boundary lines 430-436 may be determined through empirical testing, modeling, and/or the like. In addition, the angles of the boundary lines 430-436 may have been determined such that sections of a 3D printed part that are formed based on the delineations identified by the boundary lines 430-436 may have a consistent optical characteristic, a consistent mechanical property, or both a consistent optical characteristic and a consistent mechanical property with respect to each other regardless of the orientations of the sections. The use of the information identified in the diagram 410 may result in the consistent characteristics, e.g., mitigation of anisotropies among the sections. The angles of the boundary lines 430-436 may also vary for different colors, e.g., may be color dependent. Thus, for instance, the angles of the boundary lines 430-436 for one color may differ from the angles of the boundary lines 430-436 for another color.

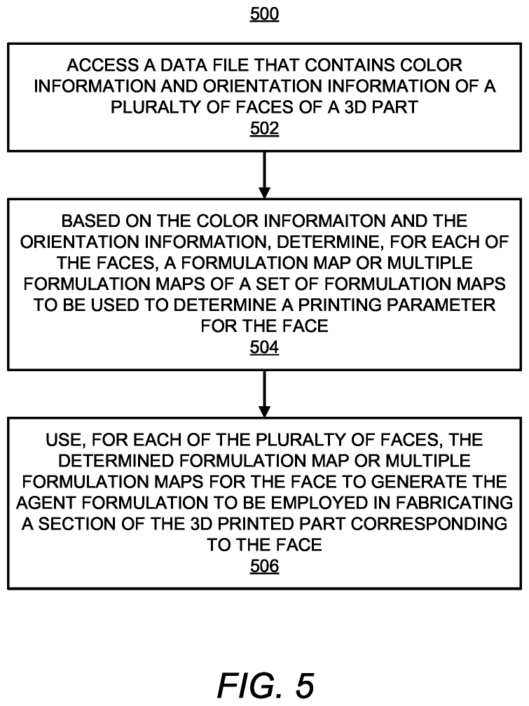

Various manners in which the processor 302 may operate are discussed in greater detail with respect to the method 500 depicted in FIG. 5. Particularly, FIG. 5 depicts a flow diagram of an example method 500 for generating an agent formulation to be employed in fabricating a section of a 3D printed part corresponding to a face of a 3D model based on an orientation of the face. It should be understood that the method 500 depicted in FIG. 5 may include additional operations and that some of the operations described therein may be removed and/or modified without departing from the scope of the method 500. The description of the method 500 is made with reference to the features depicted in FIGS. 1-4B for purposes of illustration.

At block 502, the processor 302 may access a data file 210 that contains orientation information 212 and color information 214 of a plurality of faces 204, e.g., surfaces 204, of a 3D model 206. At block 504, the processor 302 may, based on the color information 214 and the orientation information 212, determine, for each face 204 of the plurality of faces, a formulation map or multiple formulation maps of a set of formulation maps 250 to be used to determine an agent formulation for the face 204. The processor 302 may determine the formulation map or the multiple formulation maps for the faces in any of the manners discussed herein. For instance, the processor 302 may determine the color and the orientation of the face 204 and may determine the formulation map or the multiple formulation maps that map or otherwise correspond to the determined color and orientation of the face 204. By of example, the processor 302 may determine a first formulation map that maps to the determined color and a first orientation and a second formulation map that maps to the determined color and a second orientation.

In addition, at block 506, the processor 302 may use, for each face 204 of the plurality of faces, the determined formulation map or multiple formulation maps for the face 204 to generate the agent formulation to be employed in fabricating a section 216 of a 3D printed part 208 corresponding to the face 204. The processor 302 may, for instance, use a single formulation map or may interpolate multiple formulation maps as discussed herein to generate the agent formulation for each of the faces 204.

According to examples, the processor 302 may store the generated agent formulations for the faces 204 in the data store 304. In addition, or alternatively, the processor 302 may communicate the generated agent formulations to the print controller 220 of the 3D fabrication system 200 and the print controller 220 may control components, e.g., the agent delivery devices 238, 240, to fabricate a 3D printed part 208 having sections 216 formed using the generated agent formulations. The print controller 220 may also form an interior or core of the 3D printed part 208 according to an agent formulation, for instance, that may be specific to the interior of the 3D printed part 208.

Some or all of the operations set forth in the method 500 may be contained as utilities, programs, or subprograms, in any desired computer accessible medium. In addition, the method 500 may be embodied by computer programs, which may exist in a variety of forms. For example, the method 500 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

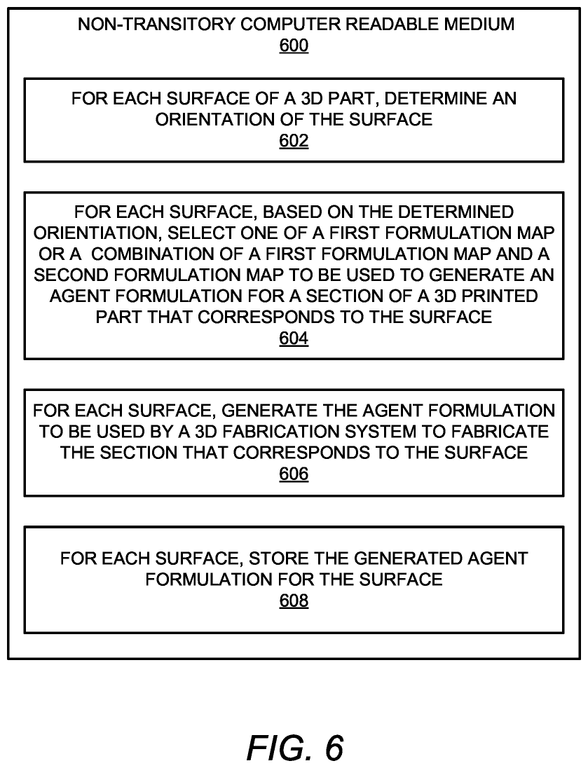

Turning now to FIG. 6, there is shown a block diagram of an example computer readable medium 600 that may have stored thereon machine readable instructions that when executed by a processor, may cause the processor to generate agent formulations to be used to fabricate a section 216 of a 3D printed part 208 that corresponds to a surface 204 of a 3D model 206. It should be understood that the computer readable medium 600 depicted in FIG. 6 may include additional instructions and that some of the instructions described herein may be removed and/or modified without departing from the scope of the computer readable medium 600 disclosed herein. The computer readable medium 600 may be a non-transitory computer readable medium. The term “non-transitory” does not encompass transitory propagating signals.

The computer readable medium 600 may have stored thereon machine readable instructions 602-608 that a processor, such as the processor 302 depicted in FIG. 3, may execute. The computer readable medium 600 may be an electronic, magnetic, optical, or other physical storage device that contains or stores executable instructions. The computer readable medium 600 may be, for example. Random Access memory (RAM), an Electrically Erasable Programmable Read-Only Memory (EEPROM), a storage device, an optical disc, and the like.

The processor may fetch, decode, and execute the instructions 602 to, for each surface 204 of a plurality of surfaces of a 3D model 206, determine an orientation of the surface 204. The processor may determine the orientation of the surface 204 from the orientation information 212 contained in a data file 210 of the 3D model 206. In addition, the processor may determine the orientation as the angle at which the surface 204 extends, a normal angle 402 of the plane at which the surface 204 extends, or another suitable angle.

The processor may fetch, decode, and execute the instructions 604 to, for each of the surfaces, based on the determined orientation of the surface 204, select one of a first formulation map or a combination of a first formulation map and a second formulation map to be used to generate an agent formulation for a section 216 of a 3D printed part 208 that corresponds to the surface 204. The first formulation map and the second formulation map may be part of a set of formulation maps 250 corresponding to a 3D fabrication system 200 that are to mitigate anisotropy among sections of the 3D printed part 208 corresponding to the plurality of surfaces of the 3D model 206. As discussed herein, the processor may select a first formulation map in instances in which the orientation of the surface 204 (or a normal angle 402 of the surface 204) is aligned with the orientation corresponding to the formulation map. In other instances, however, the processor may select a combination of a first formulation map and a second formulation map as discussed herein.

The processor may fetch, decode, and execute the instructions 606 to, for each of the surfaces, generate, using the selected first formulation map or the combination of the first formulation map and the second formulation map, the agent formulation to be used by the 3D fabrication system 200 to fabricate the section 216 of the 3D printed part 208 that corresponds to the surface 204. That is, the processor may generate the agent formulation using the agent information identified in the first formulation map and/or the combination of the first formulation map and the second formulation map. As discussed herein, the use of the combination of the first formulation map and the second formulation map may include an interpolation of the agent identified in the first formulation map and the second formulation map.

The processor may fetch, decode, and execute the instructions 608 to store the generated agent formulation for the surfaces. The processor may store the generated agent formulations in the data store 304. In addition, or alternatively, the processor may communicate the generated agent formulations to the print controller 220 of the 3D fabrication system 200 and the print controller 220 may control components, e.g., the agent delivery devices 238, 240, to fabricate a 3D printed part 208 having sections 216 formed using the generated agent formulations.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
identify an orientation of a surface of a three-dimensional (3D) model; and
based on the identified orientation of the surface, determine an agent formulation to be employed in fabricating a section of a 3D printed part corresponding to the surface, wherein each of a plurality of different orientations of surfaces of the 3D model correspond to a respective different agent formulation.

2. The apparatus of claim 1, wherein the instructions are further to cause the processor to:
based on the identified orientation, select a formulation map or multiple formulation maps from a set of formulation maps; and
determine the agent formulation using the selected formulation map or the selected multiple formulation maps.

3. The apparatus of claim 2, wherein the instructions are further to cause the processor to select the formulation map or the multiple formulation maps to cause the section of the 3D printed part to have a consistent optical characteristic, a consistent mechanical property, or both a consistent optical characteristic and a consistent mechanical property with respect to other sections having other orientations in the 3D printed part.

4. The apparatus of claim 2, wherein the set of formulation maps includes a first formulation map for a first orientation and a second formulation map for a second orientation and wherein the instructions are further to cause the processor to:
determine that the identified orientation of the surface falls between the first orientation and the second orientation;
select the first formulation map and the second formulation map to be applied to the surface; and
interpolate the first formulation map and the second formulation map to determine the agent formulation to be employed in fabricating the section of the 3D printed part corresponding to the surface.

5. The apparatus of claim 4, wherein the instructions are further to cause the processor to weight first agent information identified in the first formulation map differently from second agent information identified in the second formulation map based on the identified orientation of the surface.

6. The apparatus of claim 5, wherein the instructions are further to cause the processor to apply a linearly weighted interpolation, an exponentially weighted interpolation, or a weighted interpolation that changes according to another mathematical function on the first formulation map and the second formulation map based on the identified orientation of the surface.

7. The apparatus of claim 1, wherein the orientation of the surface comprises a normal angle from an angle at which the surface extends.

8. A method comprising:
accessing, by a processor, a data file that contains color information and orientation information of a plurality of faces of a three-dimensional (3D) model;
based on the color information and the orientation information, determining, by the processor, for each face of the plurality of faces, a formulation map or multiple formulation maps of a set of formulation maps to be used to determine an agent formulation for the face; and
using, by the processor, for each face of the plurality of faces, the determined formulation map or multiple formulation maps for the face to generate the agent formulation to be employed in fabricating a section of a 3D printed part corresponding to the face.

9. The method of claim 8, wherein determining the formulation map or the multiple formulation maps for a face further comprises determining, from the set of formulation maps, the formulation map or the multiple formulation maps that are to cause the section of the 3D printed part to have a consistent optical characteristic, a consistent mechanical property, or both a consistent optical characteristic and a consistent mechanical property with respect to other sections corresponding to other faces in the plurality of faces.

10. The method of claim 8, wherein the set of formulation maps includes a first formulation map for a first color and a first orientation and a second formulation map for the first color and a second orientation, the method further comprising:
determining that the identified color information of a first face matches the first color;
determining that the identified orientation information of the first face falls between the first orientation and the second orientation;
determining that the first formulation map and the second formulation map are to be used to determine the agent formulation for the first face; and
interpolating the first formulation map and the second formulation map to generate the agent formulation to be employed in printing a first section of the 3D printed part corresponding to the first face.

11. The method of claim 10, further comprising:
applying a weighting operation on first agent information identified in the first formulation map differently from second agent information identified in the second formulation map based on the identified orientation information of the first face.

12. The method of claim 11, wherein applying the weighting operation further comprises applying a linearly changing weighting, an exponentially changing weighting, or a weighted interpolation that changes according to another mathematical function on the first formulation map and the second formulation map based on the identified orientation information of the first face.

13. A non-transitory computer readable medium on which is stored machine readable instructions that when executed by a processor, cause the processor to:
for each surface of a plurality of surfaces of a three-dimensional (3D) model,
determine an orientation of the surface;
based on the determined orientation of the surface, select one of a first formulation map or a combination of a first formulation map and a second formulation map to be used to generate an agent formulation for a section of a 3D printed part that corresponds to the surface, the first formulation map and the second formulation map being part of a set of formulation maps corresponding to a 3D fabrication system that are to mitigate anisotropy among sections of the 3D printed part corresponding to the plurality of surfaces of the 3D model;
generate, using the selected first formulation map or the combination of the first formulation map and the second formulation map, the agent formulation to be used by the 3D fabrication system to fabricate the section of the 3D printed part that corresponds to the surface; and
store the generated agent formulation for the surface.

14. The non-transitory computer readable medium of claim 13, wherein the instructions are further to cause the processor to:
for each surface of the plurality of surfaces,
determine a normal angle of the surface from the determined orientation;
determine where the normal angle falls within a range of angles; and
select one of the first formulation map or the combination of the first formulation map and the second formulation map based on the determination of where the normal angle falls within the range of angles.

15. The non-transitory computer readable medium of claim 14, wherein the instructions are further to cause the processor to:
apply an interpolation of first agent information identified in the first formulation map and second agent information identified in the second formulation map based on the determination of where the normal angle falls within the range of angles.
